(19) United States
(12) Patent Application Publication
(10) Pub. No.: US 2017/0101782 A1
(43) Pub. Date: Apr. 13, 2017

(54) SERVICE CONNECTION ROOM PLACED OUTSIDE FOR FORMING A SERVICE CONNECTION

(71) Applicant: HWR SYSTEM GMBH, Bielefeld (DE)

(72) Inventors: Mirsada Becirovic, Bielefeld (DE); Beate Willer, Bielefeld (DE)

(73) Assignee: HWR SYSTEM GMBH, Bielefeld (DE)

(21) Appl. No.: 15/312,260

(22) PCT Filed: May 27, 2015
(86) PCT No.: PCT/EP2015/001078

§ 371 Date: Nov. 18, 2016

(30) Foreign Application Priority Data
May 27, 2014 (DE) 10 2014 007 672.5

(51) Int. Cl. E04C 2/52; E04B 5/48; E02D 29/12; H02G 3/22; H02G 9/10

(52) U.S. Cl. CPC E04C 2/52; H02G 3/22; H02G 9/10; E02D 29/12; E04B 5/48

(57) ABSTRACT

An external service connection room for forming a service connection for a building outside the building, particularly for at least one residential building, having a main body designed to accommodate components and devices for the service connection, particularly shut-off apparatuses as well as control and metering devices together with pipelines and electrical lines. The main body has a feed-through as building entrance in the form of a multi-branch entrance which is designed to accommodate a plurality of supply lines, particularly for the provision of electricity and gas, communication and drinking water as well as possible district heat. The main body is designed as accessible room cell that is intended to be arranged outside the building.

### STATEMENT OF RELATED APPLICATIONS

This application claims the benefit of and is the US National Phase of International Application No. PCT/EP2015/001078 having an International Filing Date of 27 May 2015, which claims the benefit of German Patent Application No. 10 2014 007 672.5 having a filing date of 27 May 2014.

### BACKGROUND OF THE INVENTION

Technical Field

The invention relates to an external service connection room for forming a house service connection for a building with the features of a service connection room placed outside in the form of a prefabricated component for forming a service connection for a building outside the building, particularly for at least one residential building.

Prior Art

The point for connecting a building to the appropriate utility and/or waste disposal companies is generally called a service connection. Hereby, it is necessary to connect the lines which are frequently installed below ground by the companies to the appropriate consumers and/or inlet connections of a building.

Thereby, for example, the supply lines are used to provide electricity as well as gas, communication, and drinking water and possibly also district heating. In contrast, disposal lines, for example, allow for the accommodation and transport of wastewater and/or rainwater.

Since the supply and/or waste disposal lines are each arranged in a stipulated depth in the soil, the service connection is frequently arranged in the plane of the basement. In case of buildings without a basement, said service connection is placed below in the area of the floor plate or the foundation.

In either case, the service connection requires penetration of the building shell, resulting in respective requirements for its tightness. For such purpose, a suitable component in the form of a building entrance is used. As part of the service connection, it serves as a secure passage for at least one of the supply lines.

Such building entrances can also accommodate a plurality of supply lines, and so there is a differentiation between single- and multi-branch entrances. In this context, the types of supply lines, which differ from one another, are called branches.

Even though the components required for the design of a service connection are known and essentially sophisticated, there are occasionally considerable expenses with regard to the accompanying earthworks. In addition to the connection to the public road network, repeated excavations are sometimes required for the complete development of a property. Hereby, the supply and waste disposal lines, frequently present roadside and thus outside of the property, must be connected to the building.

The fact that the individual lines are frequently operated by different companies and providers often results in repeated excavation and backfilling of the required ditches. In addition to the resulting high costs, precise scheduling for the realization of a service connection is also made significantly more difficult.

In addition, the providers frequently insist on an enclosed condition of the structural shell, i.e. preventing trespassers from entering the building. This requires the lockability of the building openings, for example, through doors and windows. For that reason, the service connection can only be installed after realization of the lockable building condition.

In this context, DE 198 17 665 C2 proposes a method, with which a plurality of branches can also be installed consecutively without further excavations and backfillings. The idea is based on a supply block which is introduced in the soil within the property. Said supply block is introduced in connection with the embedding of the water line. The central idea is to provide individual lines within the supply block which are connected to the service connection and are connectable consecutively by the providers.

In this manner, the required earthworks are reduced to a minimum. In addition, no expensive coordination of the connection appointments by the providers is required.

Since the design of the service connection, particularly the building entrance for buildings with a basement, requires a core drilling that penetrates the basement wall, the already arranged insulation and/or damping of the basement plane is inevitably damaged.

For this purpose, DE 101 58 582 A1 proposes a geometrically stable prefabricated component which has penetrations in the form of prefabricated sleeve elements. The sleeve elements are intended to provide the necessary feed-through, for example for pipes, cables, hoses, and ducts. As a result, subsequent work on the building shell is omitted because it already has the required feed-through in order to realize a service connection.

Furthermore, from DE 92 07 543 U1, an accessible shaft structure made of at least one prefabricated component is known which is purely designed as a water supply. For this purpose, the shaft structure comprises a shaft installation already arranged in its interior as well as at least two wall feed-through arranged in walls of the shaft structure which are facing each other. For example, the shaft installation has a slide valve. Due to the proposed design, a high degree of prefabrication is achieved, and so the shaft structure can be transported in its entirety to its installation site and installed in the soil. The use requires the connection of intake and drain pipes with the shaft installation which have to be guided through the wall feed-through into the interior of the shaft structure.

Through DE 102 33 981 A1, a service connection shaft has become known which serves as accommodation and distribution of development as well as supply and disposal lines for a building. The objective is the reduction of the required earthworks for realizing the service connection of a building to the supply and disposal network. For such purpose, the service connection shaft is arranged below ground and comprises at least one prefabricated hollow lower part and a cover plate. The lower part has a plurality of openings in its individual side walls in order to provide inlets and outlets for the lines. From this point, said lines can be connected with connection lines extending to the building with further openings being provided for said connection lines in a sidewall of the lower part which faces the building. The connection lines extending into the building are subsequently used for forming the service connection within the building. Therefore, the service connection shaft is a junction between the existing development, supply and disposal lines and the service connection room to be installed within the building.

DE 100 23 399 A1 also pursues the basic idea of providing easier access to the main lines (e.g. gas, water, district heating) which are running past a property without the necessity of a sometimes repeated excavation. For such purpose, the arrangement of a utility, revision, and distribution shaft in the form of an underground accessible structural shell is proposed, through which the main lines are guided. In this manner, the individual main lines can be reached freely accessibly via a central entrance created in said structural shell without requiring an otherwise necessary excavation with subsequent backfilling. Once the building to be connected to the main lines is erected, the connection lines for connecting the underground shell structure with the building can be laid in the property and by means of the openings provided in the underground shell structure, they can be inserted into said shell structure. Subsequently, the individual supply/disposal provider can enter the underground shell structure time-independently and, for example, attach tapping sliders to the appropriate main line(s) in order to realize the connections of the corresponding connection line(s). The upper side of the structural shell is designed to have a depression, and so the main power cables can be guided over the structural shell in the area of the depression outside of the structural shell. Furthermore, an angled plate, spaced apart from the structural shell, can be provided which serves the forming of a connection located on the side of the road opposite of the structural shell. This will be supplemented by empty conduits extending between the angled plate and the underground structural shell. As a result, the connection lines can be guided to the provided service connection room of the respective building either directly from the underground structural shell or by interposing the angled plate. In the service connection room, the required components and devices, such as shut-off apparatuses, control and metering devices as well as pipelines and electrical lines for forming the service connection are arranged.

U.S. Pat. No. 3,438,157 A describes a cube-shaped shaft made of individual prefabricated concrete components which is provided to be set up within an excavation. In this arrangement, the shaft serves the sectional encompassing of pipes laid in the ground with conduit cables extending in said pipes. For such purpose, the shaft comprises a box-like lower section and a box-like upper section which corresponds to the lower section. The lower section is divided into two separate parts with L-shaped profile which are connectable with each other by means of fasteners after having been placed in the assembly. By contrast, the upper section is designed as one piece, wherein at least two of its opposite sidewalls have cutouts extending to their corresponding lower edge. The cutouts are provided for encompassing the conduit cables surrounded by the pipes. On the upper side of the upper section, an opening is provided for allowing accessibility.

DE 18 05 381 A1 proposes a prefabricated accessible shaft consisting of a monolithic upper shaft part and a monolithic lower shaft part, serving as cable shaft for power lines. For such purpose, the shaft has recesses arranged in its sidewalls for cable inlets, through which the respective cables can be guided into and out of the shaft.

DE 10 2009 060 439 A1 describes a waste water collection shaft, having an intake and a drain offset in height with regard to the intake. The waste water collection shaft further comprises a lifting unit. Within the waste water collection shaft, a device for reclamation of the residual heat of the waste water with at least one heat exchanger is additionally provided. Therefore, the waste water collection shaft is provided for heat reclamation.

Considering the interior of a building, the service connection requires a corresponding service connection room or at least a suitable service connection wall. In either case, this refers to an interior area of the building which is virtually unusable as living space. This is essentially due to the space required for the components and devices to be arranged, including, for example shut-off apparatuses, control and metering devices as well as pipelines and electrical lines, to name but a few. Furthermore, there are possible safety regulations and the required accessibility for maintenance and readings.

As a result, expensive and sometimes scarce living space is lost. This becomes even more apparent if the trend in new construction of foregoing a basement is taken into consideration, which would otherwise make the loss of space more tolerable. This fact alone makes it clear that the forming of service connections thus continues to leave room for improvements.

### BRIEF SUMMARY OF THE INVENTION

Against this backdrop, the present invention addresses the problem of providing a cost-efficient option for realizing a service connection which has only a small space requirement in the interior of a building and simultaneously offers high flexibility.

According to the invention, the problem is solved by an external service connection room in the form of a prefabricated component for forming a service connection for a building outside the building, particularly for at least one residential building, comprising a main body which is designed as accessible room cell having a feed-through, said main body being provided to accommodate components and devices for the service connection, particularly shut-off apparatuses as well as control and metering devices together with pipelines and electrical lines, wherein the feed-through has a building entrance in the form of a multi-branch entrance which is designed to accommodate a plurality of supply lines, particularly for the provision of electricity and gas, communication, drinking water and possible district heat. Advantageous developments of the basic inventive idea are subject matter of the dependent patent claims.

Accordingly, at first an external service connection room is described which is used to form a service connection for a building outside of the building. In particular, the building can be at least one residential building.

The external service connection room comprises a main body, having at least one feed-through. The main body is designed to accommodate components and devices for the service connection, in particular shut-off apparatuses and control and metering devices together with pipelines and electrical lines. The feed-through, having a building entrance in the form of a multi-branch entrance, is designed to accommodate a plurality of supply lines, i.e. the supply lines can be fed through the feed-through, thus particularly providing electricity and gas, communication, and drinking water and possible district heat.

According to the invention, the main body is designed as an accessible room cell. In this respect, the main body can be a preferably self-supporting hollow body which is designed such that it can be accessed by a person. Particularly with regard to the planned position of the hollow body, the invention provides for the hollow body to be arranged outside of the corresponding building.

Due to the initial resulting advantage, it is now possible to design the service connection outside the building. In other words, the main body positioned outside the building provides sufficient space which can effectively be used as an external service connection room. This way, the cubature enclosed by the building envelope remains preserved to a significantly higher degree, e.g. for residential use.

Since the main body can be delivered as a self-contained prefabricated component, a self-containable room is directly available. As a result, the provider connections can advantageously be installed independently from the actual construction progress of the building.

Particularly preferably, the service connection room placed outside can be arranged in a corresponding excavation on the property, particularly underground. An advantageous position could, for example, touch the property line in order to reduce to a minimum the frequently deep excavations for the connections of the providers to the service connection.

According to the invention, the feed-through can be viewed as building entrance.

Since the prefabricated component must be effectively viewed as an independent service connection room, the actual connection to the infrastructure of the corresponding building can be made at a time which is to be seen as suitable during the overall course of events. Particularly, the connection of the service connection room placed outside with the building is almost independent from the connection to be installed by the provider.

Due to the already present feed-through, it no longer has to be subsequently introduced in the structural shell. This also applies to the multiple excavations and backfillings which are sometimes required for installing all branches. Ideally, the required lines can now be laid in one operational step between the external service connection room and the building.

Furthermore, possible projects for changes and/or expansions of the service connection are reduced to the external service connection room, and so the building envelope is sometimes only slightly affected or not at all. This is the case particularly in connection with systems to be possibly installed subsequently and which, for example, serve to generate energy. Since the generated or excess energy is frequently fed into the operator's network, the required transfer point with all its work can be thus reduced to the service connection room placed outside.

Particularly in view of the development of a building site and the construction of a plurality of buildings, there is the additional possibility of using possible synergy effects. With the example of five town houses or single-family houses, it quickly becomes apparent that five service connections have to be routinely realized at five different points in time. Provided that there is agreement between the individual owners, they can share a common service connection room with regard to the service connection room according to the invention. This merely requires one individual connection, whereas the connections to the individual buildings can be made at points in time different from one another. At times, the costs essentially incurring for the development can thus be significantly reduced.

This advantage naturally also applies to possible subsequent work which also has to be done only in the service connection room according to the invention.

According to an advantageous development of the invention, the main body can have walls delimiting the main body at least on its sides. Hereby, it is planned that the feed-through advantageously can be arranged in one of those walls.

Of course, it is also conceivable that the feed-through can be arranged in a floor plate which delimits the main body of the external service connection room toward the bottom. This depends essentially on the issue of accessibility of the feed-through for the provider or disposer and its stipulations, and the decision required therefor must be made by a respective person skilled in the art.

The invention provides for the main body to preferably have one lockable access opening. In this context, the access opening is designed to allow access to the interior of the main body. In other words, the access opening is designed to make it possible to reach the interior of the main body.

This way, access to the service connection can be made possible to the provider(s) independently from an entering of the building. For example, the required access means, such as a key, can be deposited at the provider, thus providing access for maintenance and repair in accordance with the provider's schedule. In addition, this also increases the temporal flexibility for the person who is responsible for the granting of access to the service connection.

Particularly preferably, the main body can be designed to accommodate a water disposal. Such water disposal can be advantageously arranged in one of the walls delimiting the main body on its sides. The water disposal can serve for transfer of waste water and/or rainwater to the public sewer system.

In this context or generally, the main body can further comprise a backflow trap and/or an inspection flap and/or an inspection shaft. As a result, this also fulfills the obligation to provide an inspection shaft or a corresponding inspection opening on the property, when the service connection room placed outside is constructed. Similarly, the service connection room simultaneously allows for unproblematic maintenance and upkeep of the necessary building and/or property drainage.

According to an advantageous embodiment, the main body can have at least one exit hole. An exit hole is an opening through the wall of the main body. The exit hole can be used to accommodate a connection line. In this respect, the exit hole can be advantageously designed such that the building is connected to the at least one supply line fed into the interior of the main body by interposing at least one connection line.

In this context, the exit hole can be arranged vertically higher with respect to the position of the feed-through. Advantageously, this makes it possible to connect the external service connection room, particularly its service connection with the building at a much shallower depth than is usually the case. In addition to a safety depth (e.g. cut of the spade) to be observed, a frost-free depth of installation must be taken into account particularly with regard to water-bearing lines. In most European zones, it is set at 80 cm. Due to the shallow trench depth, a considerable cost-savings can be achieved.

In reference to accessibility, the exit hole can preferably be arranged in one of the walls delimiting the main body.

If a plurality of buildings is provided with a single service external connection room, the savings per building increase disproportionately because the costs for the service connection room and its installation are still incurred only once.

According to an advantageous development, the main body can be designed to accommodate a means for generating energy. For example, such a means can be a block-type thermal power station (BTTP). Due to the thus-resulting power-heat coupling, the BTTP can be used for providing the building with electricity and heat. The arrangement of the means for generating energy within the main body also provides a space gain with regard to the interior of the building.

Previous solutions provide for the arrangement of such means for generating energy within the building, and so their energy is regularly only available for one individual building. Due to the invention, it is now possible to connect more than one building to a central means for generating energy which is arranged within the service connection room according to the invention.

This results in a number of advantages, and so the feed-in of solar energy or the generation of electricity, for example, no longer has to be effected by means of a plurality of feed points. Furthermore, possible reclamation circuits can be conveniently connected with each other. The utilization of effective techniques for individual households also becomes more attractive, since their sometimes high acquisition costs can be apportioned to a number of buildings. This also applies to the inevitable follow-up costs, such as maintenance and repair and meter reading. In addition, retrofitting on only one central point is correspondingly simpler and thus more cost-efficient.

With reference to the external service connection room, its main body can preferably be made, at least partially, of concrete, particularly reinforced concrete. Particularly preferably, this can be a main body entirely made of concrete, particularly reinforced concrete.

Further embodiments of the external service connection room can be the result of a technically meaningful combination of individual or a plurality of features and measures identified in the above description and are also expressly claimed within the scope of the invention. Further characterizations and specifications of the invention can result in connection with the drawings described in the following and which are also deemed to be and claimed as part of the invention.

### BRIEF DESCRIPTION OF THE DRAWINGS

In the following, the present invention shall be explained in more detail using some embodiments schematically depicted in the drawings.

FIG. 1 shows a perspective view of an external service connection room according to the invention;

FIG. 2 shows the same representation of the service connection room according to the invention from FIG. 1 in preparation of an alternative embodiment; and

FIG. 3 shows the alternative embodiment of the service connection room according to the invention from FIG. 2 as complete embodiment in the same representation.

### DETAILED DESCRIPTION OF PREFERRED EMBODIMENTS

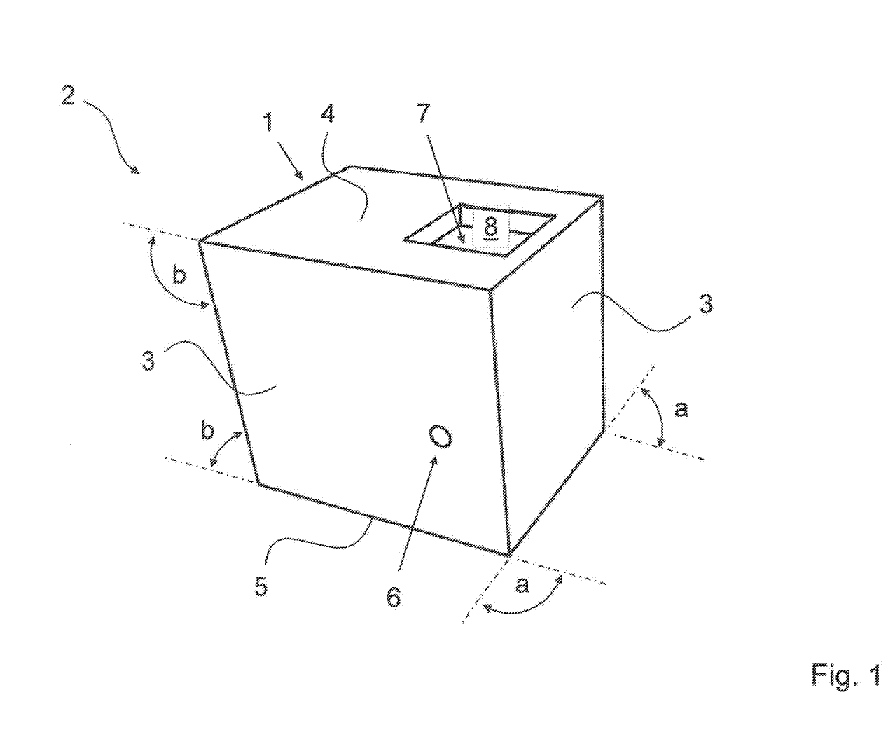

FIG. 1 shows a main body 1 of an external service connection room 2 according to the invention, which is suitable for forming a service connection for an unspecified building.

As can be seen, the main body 1 is designed as hollow body. The dimensions of the main body 1 are selected such that it can be used as accessible room cell. For that purpose, the main body 1 has in this embodiment a total of four side walls 3. Respectively, two of the walls 3 are parallel, wherein the immediately adjacent walls 3 form an angle a between each other. The angle a can preferably be a right angle, and so the angle a has a value of 90°.

Due to a ceiling plate 4 resting on the walls 3 and a floor plate 5 supporting the walls 3, the main body 1 is enclosed from all sides. The ceiling plate 4 and the floor plate 5 are also parallel to each other, wherein both the ceiling plate 4 and the floor plate 5 each form an angle b between each of the ceiling plate 4 and the walls 3 and of the floor plate 5 and the walls 3. Preferably, this angle b can also have a value of 90°, thus resulting in a right-angled box shape for the main body 1.

Preferably, the main body 1, at least partially, can be made of concrete. Particularly against the backdrop of a self-supporting design of the main body 1, the concrete can advantageously be reinforced. Ideally, the main body 1 can be made entirely of reinforced concrete. This allows for a simple and cost-effective prefabrication of the main body 1 and/or the service connection room 2 in an appropriate factory. Even though the main body 1 can be provided with a black (bituminous) sealing of its outer shell with regard to its required tightness, the main body 1 can preferably be made of waterproof concrete (WP concrete). In addition to the necessary additives, the appropriate minimum values for wall thickness and/or degree of reinforcement must be observed correspondingly.

The main body 1 of the service connection room 2 is intended to be arranged outside of the unspecified building. In this position, the main body 1 effectively serves as an external service connection room 2, and so a maximum of living space and/or usable floor space remains within the building. In order to solve this problem, the service connection room 2 must provide the option of offering a connection to the networks of the providers and/or waste disposal companies.

According to the invention, this is solved as follows:

In one of the walls 3, an opening can be seen which serves as feed-through 6 through the corresponding wall 3. In its design as feed-through 6, it is designed to accommodate at least one herein unspecified supply line. In this respect, the feed-through 6 is provided to allow for at least one supply line which is positioned outside of the main body 1 to be introduced into the main body 1. In this manner, the feed-through 6 acts as building entrance, particularly as an upstream building entrance.

The service connection room 2 according to the invention thus offers the advantageous option of accommodating the herein unspecified periphery in connection with a service connection. In this context, shut-off apparatuses, control and metering devices as well as pipelines and electrical lines must be named as examples. Furthermore, the main body 1 can also be designed to accommodate a herein unspecified water disposal. This can either be integrated within the feed-through 6 or be designed as separate receptacle, for example in the form of a further opening. Preferably, this receptacle can be arranged in one of the walls 3 or the floor plate 5.

Furthermore, for the utilization of the service connection room 2 according to the invention, it must be suitably accessible. As can be seen, the ceiling plate 4 presently has an access opening 7 which can meet this requirement. For example, it is conceivable that herein unspecified stairs or a ladder are arranged within the hollow main body 1 which can be reached via the access opening 7. Particularly preferably, the access opening 7 is lockable in a herein unspecified manner, for example by means of a locking element, such as a herein unspecified door or shutter, that is lockable and unlockable from the outside. In either case, the access opening 7 is designed to provide access to the interior 8 of the main body 1 or the service connection room 2 through said access opening 7.

The arrangement of the access opening 7 depicted herein must be considered to be exemplary. Of course, it can also be arranged in one of the walls 3 of the main body 1. Since the service connection room 2 is preferably at least to some extent arranged in the soil, a suitable access route is required for a correspondingly lateral access opening 7. Said access route can be formed, for example, by a flight of stairs located on the side of the main body 1.

The actual dimensioning of the main body 1, particularly its inner dimensions, must be selected by the appropriate expert. For example, said dimensions might follow from the statutory and/or municipal as well as provider-stipulated specifications which regularly determine minimum dimensions for such a service connection room 2. The backdrop is the unrestricted possibility of accessing said service connection room 2 in order to be able to perform maintenance or meter readings.

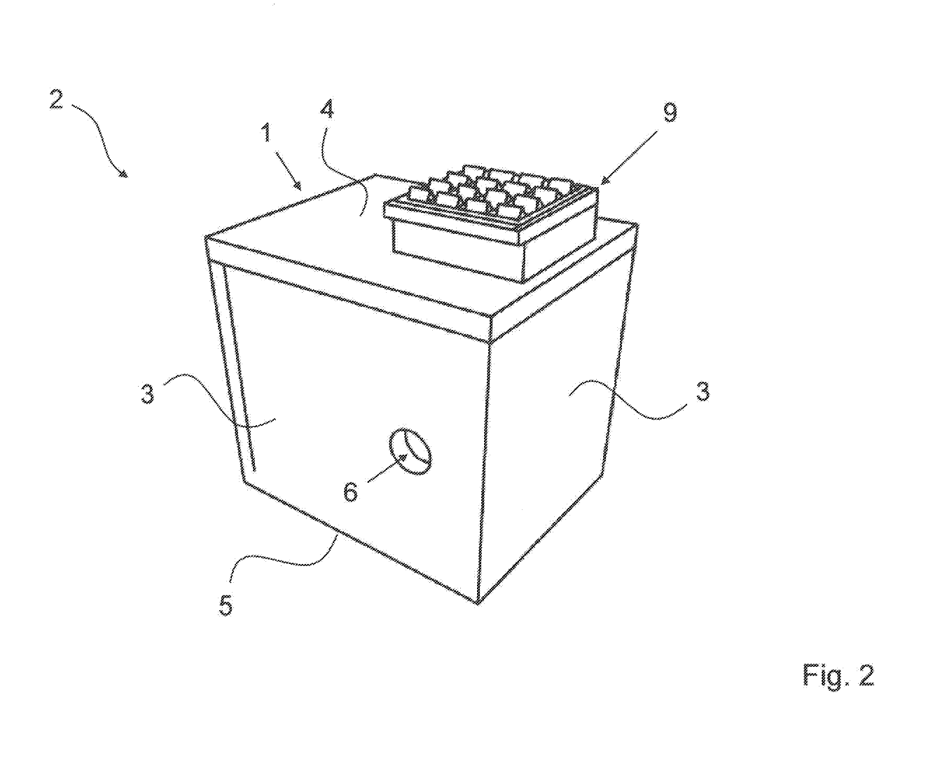

FIG. 2 shows the external service connection room 2 from FIG. 1 in an alternative embodiment. As can be seen, the main body 1 now comprises an access hatch with ventilation grille 9. Particularly preferably, it can be combined with a receptacle for a herein unspecified water disposal. As a result, the service connection room 2 according to the invention can simultaneously allow for the easy maintenance and upkeep of the necessary building and/or property drainage. Due to the accessibility of the service connection room 2, no inspection shaft must be additionally installed and connected on the property.

In order to achieve a further connection of the supply lines connected to the service connection room 2 to the corresponding building, the main body 1 has at least one herein unspecified exit hole. Preferably, the exit hole can be arranged in one of the walls 3 which delimit the main body 1. Of course, an arrangement in the floor plate 5 is also conceivable.

In its arrangement, the herein unspecified exit hole can subsequently accommodate at least one connection line. As a result, the corresponding building can be connected to the at least one supply line fed into the interior 8 of the main body 1 by interposing the connection line.

With reference to further cost savings with regard to required earthworks, the herein unspecified exit hole in question provides for the possibility of installing the connection line to the building, for example, only at a frost-free depth. Since the lines from providers and disposal companies are installed at a significantly lower depth, corresponding savings can be achieved with an appropriately higher installation of the at least one supply line between the service connection room 2 placed outside and the building. For such purpose, the exit hole, with regard to its position, can be arranged vertically higher than the feed-through.

Further conceivable is the arrangement of a herein unspecified means for generating energy, for example a block-type thermal power station (BTTP), a combined heat and power installation (CHP), a geothermal device, etc. For that purpose, the main body 1 can ideally be designed to accommodate such a means for generating energy. Both in this context and generally, the service connection room 2 according to the invention can be used to be connected to more than one building. This results in various savings possibilities which have already been addressed in detail beforehand.

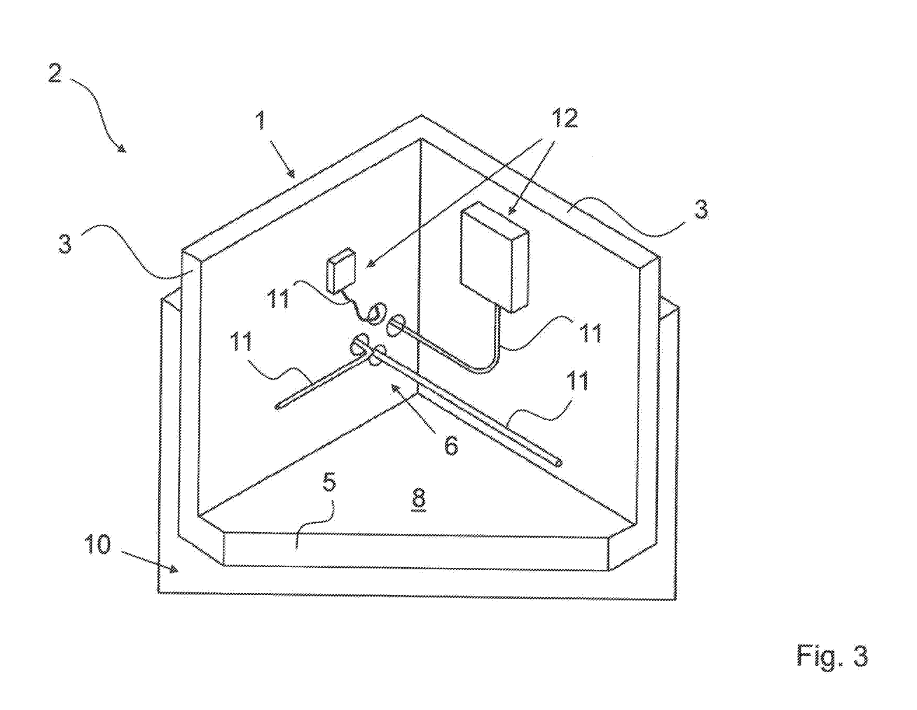

FIG. 3 once again illustrates the interior 8 of the main body 1 in a perspective partial section. It is predominantly placed in a soil 10. In particular, the feed-through 6 can be identified which serves to accommodate supply lines 11. In the interior 8 of the main body 1, at least some of the supply lines 11 are connected to a periphery 12 already addressed above.

1. An external service connection room in the form of a prefabricated component for forming a house service connection for a building outside the building, particularly for at least one residential building, comprising a main body (1) which is designed as accessible room cell having a feed-through (6), said main body (1) being provided to accommodate components and devices for the house service connection, particularly shut-off apparatuses as well as control and metering devices together with pipelines and electrical lines, wherein the feed-through (6) has a building entrance in the form of a multi-branch entrance which is designed to accommodate a plurality of supply lines (11), particularly for the provision of electricity and gas, communication, drinking water and possible district heat.

2. The external service connection room according to claim 1, wherein the main body (1) has walls (3) which delimit the service connection room, wherein the feed-through (6) is arranged in one of the walls (3).

3. The external service connection room according to claim 1, wherein the main body (1) has a lockable access opening (7), wherein the access opening (7) is designed to provide access to an interior (8) of the main body (1) through the access opening (7).

4. The external service connection room according to claim 1, wherein the main body (1) has a receptacle for a water disposal.

5. The external service connection room according to claim 1, wherein the main body (1) comprises an inspection shaft (9).

6. The external service connection room according to claim 1, wherein the main body (1) has at least one exit hole, wherein the exit hole is provided for accommodating at least one connection line and is designed to connect the building to the at least one supply line fed into the interior of the main body (1) by interposing at least one connection line.

7. The external service connection room according to claim 6, wherein the exit hole with regard to its position is arranged vertically higher than the feed-through (6).

8. The external service connection room according to claim 6, wherein the exit hole is arranged in one of the walls (3) delimiting the main body (1).

9. The external service connection room according to claim 1, characterized in that the main body (1) is designed to accommodate a means for generating energy.

10. The external service connection room according to claim 1, wherein the main body (1) is made, at least to some extent, of reinforced concrete.

11. The external service connection room according to claim 1, wherein it is arranged underground.

12. The external service connection room according to claim 2, wherein the main body (1) has a lockable access opening (7), wherein the access opening (7) is designed to provide access to an interior (8) of the main body (1) through the access opening (7).

13. The external service connection room according to claim 7, wherein the exit hole is arranged in one of the walls (3) delimiting the main body (1).
